(19) United States
(12) Patent Application Publication
(10) Pub. No.: US 2007/0213194 A1
(43) Pub. Date: Sep. 13, 2007

(54) Glass Substrates for flat screens

(75) Inventors: Sylvie ABENSOUR, Montlignon (FR); David Louapre, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT GOBAIN GLASS FRANCE, Courbevoie (FR)

(21) Appl. No.: 11/682,361

(22) Filed: Mar. 6, 2007

Related U.S. Application Data
(60) Provisional application No. 60/788,726, filed on Apr. 4, 2006.

(30) Foreign Application Priority Data
Mar. 10, 2006 (FR) 06/50826

(51) Int. Cl. C03C 3/091

(52) U.S. Cl. 501/66

(57) ABSTRACT

A glass substrate, method for providing a glass substrate, and composition having or using a chemical composition including the following constituents, expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

M₂O denoting one or more alkali metal oxides, where at least one of the following provisos are met: 1.) BaO less than 1% and MgO greater than or equal to 2%; 2.) MgO greater than or equal to 4%;

3.) B₂0₃ greater than or equal to 12%.

### REFERENCE TO PRIOR APPLICATIONS

This application claims priority to U.S. provisional application 60/788,726 filed Apr. 4, 2006, and to French patent application 06/50826 filed Mar. 10, 2006, both incorporated herein by reference.

### FIELD OF THE INVENTION

The present invention relates to glass compositions and glass substrates made from the glass compositions. Preferably, the invention substrates are capable of being used for the manufacture of flat screens, and have aluminosilicate compositions with low contents of alkali metal oxides.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Flat screens can be produced by different technologies, among which the main ones are the PDP (plasma display panel) and LCD (liquid crystal display) technologies. Both technologies are based on the use of glass substrates, but they require extremely different properties of these substrates, and so their chemical composition must be specifically adapted to each.

LCD technology employs manufacturing methods in which thin glass sheets are used as substrates for deposition of thin-film transistors by techniques used in the semiconductor industry for electronic devices, including the techniques of high-temperature deposition, photolithography and chemical etching. Numerous requirements related to the properties of the glass arise from these methods, particularly as regards mechanical, chemical and thermal resistance.

In view of the high temperatures employed for deposition of thin films of silicon, thermal stability of the glass is imperative if deformation is to be avoided. Depending on the technology employed (amorphous or polycrystalline silicon), a lower annealing temperature of at least 600° C. and even 650° C. is then required. This temperature is commonly known as “strain point”, and it corresponds to the temperature at which the glass has a viscosity equal to 10^{14.5} poise. A low coefficient of expansion is also necessary in order to avoid excessively large variation of the dimensions of the glass substrate as a function of temperature. Nevertheless, good agreement between the coefficient of expansion of the silicon and that of the glass is indispensable in order to avoid the creation of mechanical stresses between the glass and the silicon. The coefficient of expansion of the glass substrate must therefore lie between 25 and 37·10⁻⁷/° C., preferably between 28 and 33·10⁻⁷/° C., as measured in the 25 to 300®C. temperature range.

Several chemical etching steps are employed in the method for manufacture of screens. Since these etching operations are achieved with acids and must not degrade the surface of the glass substrates, it is indispensable that this substrate have very high resistance to acid corrosion especially as regards resistance to hydrofluoric acid buffered by ammonium fluoride (the “BHF” test) and to hydrochloric acid.

In view of the continuing increase in size of flat screens, it is also important that the weight of the substrate be minimized; for the glass being used, this corresponds to a requirement of low density (weight per unit volume). Low density, in common with Young's modulus, is also an important factor in avoiding deflection of large-size substrates and thus in facilitating manipulation of the said substrates during all steps of the method for manufacture of screens.

Certain properties of the glass are also important as regards the industrial feasibility of glass substrates. In particular, if the high-temperature viscosity is too great, it would have economic consequences since it would increase the energy expenses and shorten the useful life of the glass melting furnaces. Another imperative requirement is that the glass not become devitrified at excessively high temperature (the liquidus temperature must therefore be limited) and/or have elevated crystallization rates, because that would be detrimental to the feasibility of forming into flat glass sheets.

### SUMMARY OF THE INVENTION

The present invention relates to new glass compositions that have good properties in terms of density, thermal stability, coefficient of expansion, corrosion resistance in acid media and that are also economic in terms of raw material costs and quantity of energy to be supplied for the manufacture of glass substrates.

### DETAILED DESCRIPTION OF THE PREFERRED EMBODIMENTS

One preferred embodiment of the invention is a glass composition and substrate made therefrom having chemical compositions comprising, consisting essentially of, and consisting of the following constituents within the limits defined hereinafter, endpoints included, expressed in percentages by weight (unless otherwise stated, all percentages by weight herein are based on total weight):

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

where M₂O denotes the total weight of one or more alkali metal oxides (preferably one or more oxides of sodium, potassium and lithium).

In a preferred embodiment herein, applicable to the invention glass substrate, method for making, and composition, at least one of the following compositional provisos are met:
1.) BaO less than 1% and MgO greater than or equal to 2%;
2.) MgO greater than or equal to 4%;
3.) B₂O₃ greater than or equal to 12%.

These “provisos” further include the following:
1.) BaO less than 0.9, 0.8, 0.7, 0.6, etc. % and MgO greater than or equal to 2.1, 2.2, 2.3, 2.4, 2.5, 2.6, etc %;
2.) MgO greater than or equal to 4.1, 4.2, 4.3, 4.4, 4.5, 4.6, 4.7, 4.8, etc %;
3.) B₂O₃ greater than or equal to 12.1, 12.2, 12.3, 12.4, 12.5, 12.6, 12.7, 12.8, 12.9, etc %.

Lower quantities of silica (i.e., below 58%) are generally not preferred, especially percentages that would lead simultaneously to degradation of the stability of the glass with respect to devitrification, too low resistance to acid corrosion, too high density and too great coefficient of expansion. It is preferable that the silica content be greater than or equal to 60%, better 61% and even 62%. On the other hand, too high contents (above 70%) are generally not preferred, especially those that have the consequence of an unacceptable increase of the viscosity, making the glass-melting process extremely difficult. The silica content of the glasses according to the invention is preferably advantageously lower than or equal to 68%, better 66% and even 63%, making all of 58-68% (i.e., 58, 59, 60, 61, 62, 63, 64, 65, 66, 67 and 68%, and all values and subranges therebetween), highly preferred.

The glass and glass substrates according to the invention preferably contain at least 10% of boron oxide (B₂O₃) and advantageously at least 11% and even 12%. Too high a content of boron oxide, however, is not preferred when it has a negative impact on the cost of the raw materials employed and on the strain point. For these reasons, the boron oxide content is preferably lower than or equal to 16%, advantageously 15% and even 14%.

The preferred content of alumina (Al₂O₃) is advantageously greater than or equal to 15%, even 16%. An elevated alumina content, however, is generally not preferred, especially if has the disadvantage of greatly increasing the high-temperature viscosity and reducing the resistance to corrosion in acid media as well as the resistance of the glass to devitrification (especially by raising the liquidus temperature). The alumina content of the glasses according to the invention is preferably advantageously lower than or equal to 22%, better 20% and even 18%. An alumina content between 15 and 16% constitutes a highly preferred embodiment.

The content of lime (CaO) is preferably greater than or equal to 2% or 3%, even 4%. On the other hand, a too high content is generally not preferred especially when it becomes detrimental to obtaining a low coefficient of expansion. A content lower than or equal to 7% and even 6% or 5% is highly preferred.

The magnesia (MgO) content is preferably lower than or equal to 8%, even lower than 7%. It has been observed that the presence of boron oxide in elevated contents in the present invention make it possible to use high MgO contents without having to suffer a too large increase of the liquidus temperature and of the crystallization rates. The MgO content is therefore preferably greater than or equal to 2%, 3%, better 4%, particularly 4.5% and even 5%.

The sum of CaO+MgO is preferably greater than or equal to 8%, in order to provide preferable high-temperature viscosity.

It is advantageous to limit the content of one or the other or both of the oxides of barium (BaO) and strontium (SrO) to 6% or lower, especially 3%, better 1% or even 0.5% or 0.1%. The glasses according to the invention advantageously do not contain strontium and/or barium oxides, except for inevitable impurities.

If zinc oxide (ZnO) is present, its content is advantageously lower than or equal to 1%, in order to avoid undesirable reactions when the glass sheet is produced by the “float” method, in which the glass is poured over a pool of molten tin under a reducing atmosphere. For glasses containing too high a ZnO content, the reducing conditions necessary to prevent oxidation of the tin bath effectively cause reduction of this oxide to metallic zinc, which forms a haze on the glass sheet.

The alkali metal oxides (M₂O collectively denoting these oxides, including the oxides of sodium, potassium and lithium) preferably are limited to very low contents, preferably lower than 0.5%, and even 0.1%, 0.05% or 0.01%. Zero contents of alkali metal oxides (except for any traces introduced from the raw materials) are preferred. The alkali metal oxides can tend to migrate to the glass surface, where they can degrade the semiconductor properties of the silicon deposited on the substrate.

According to another preferred embodiment, the invention glass and glass substrate made therefrom according to the invention has chemical compositions comprising, consisting essentially of, and consisting of the following constituents within the limits shown, endpoints included, expressed in percentages by weight:

| | |
|---|---|
| SiO₂ | 58 to 63 |
| B₂O₃ | 12 to 16 |
| Al₂O₃ | 14 to 25 |
| CaO | 2 to 10 |
| MgO | 1 to 10 |

According to another preferred embodiment, the invention glass and glass substrate made therefrom according to the invention has chemical compositions comprising, consisting essentially of, and consisting of the following constituents within the limits shown, endpoints included, expressed in percentages by weight:

| | |
|---|---|
| SiO₂ | 58 to 70 |
| B₂O₃ | 10 to 16 |
| Al₂O₃ | 14 to 25 |
| CaO | 2 to 10 |
| MgO | 4 to 10 |

According to another preferred embodiment, the invention glass and glass substrate made therefrom according to the invention has chemical compositions comprising, consisting essentially of, and consisting of the following constituents within the limits shown, endpoints included, expressed in percentages by weight:

| | |
|---|---|
| SiO₂ | 58 to 62 |
| B₂O₃ | 10 to 16 |
| Al₂O₃ | 14 to 25 |
| CaO | 2 to 4 |
| MgO | 4 to 10 |
| CaO + MgO | 8 to 12 |
| BaO | 0 |
| SrO | <3, preferably 0 |

The compositions of this embodiment are free of barium oxide and preferably of strontium oxide, except for inevitable impurities introduced from the raw materials.

The glass and glass substrates according to the invention can contain components other than those listed in the foregoing. Examples include fining agents, introduced purposely, or other oxides, generally introduced involuntarily and not substantially modifying the manner in which the substrates according to the invention solve the technical problem in question. In general, the impurities content of the glasses according to the invention is preferably lower than or equal to approximately 5%, better 3% and even 2% or 1%.

The glass compositions and substrates according to the invention preferably contain chemical agents designed for fining of the glass, or in other words eliminating gaseous inclusions present in the glass mass during the melting step. Examples of fining agents used are oxides or arsenic or antimony, halogens such as fluorine or chlorine, tin or cerium oxide, sulfates or a mixture of such compounds. The association of tin and chlorine has proved particularly effective and is therefore preferred within the scope of the present invention. The compositions and substrates according to the invention preferably do not contain oxides of arsenic or antimony, by reason of their elevated toxicity. Another particularly advantageous family of fining agents is the sulfides, particularly zinc sulfide (ZnS), especially in association with an oxidizing agent such as tin oxide.

The glass and glass substrates according to the invention can also contain quantities of other oxides, such as zirconium or titanium oxides or oxides of rare earths such as lanthanum or yttrium (which make it possible to increase Young's modulus), but they preferably do not contain such oxides, with the exception of traces introduced from impurities present in the raw materials or introduced by dissolution of components present in the refractory materials of which the glass-melting furnace is made. Depending on the case, these oxides may be present in contents that generally do not exceed 2%, or even 1%.

In order to improve the resistance of the glasses to corrosion in acid media, it can be advantageous to add a limited content of zirconium oxide (ZrO₂) to the compositions of the invention, especially in amounts between 0.4 and 1.5% and preferably between 0.5 and 1.2%. Care should be exercised, as this oxide can strongly degrade the devitrification properties.

The glass substrates according to the invention preferably have a coefficient of expansion smaller than or equal to 33·10⁻⁷/° C., even 32·10⁻⁷/° C. Their strain point is preferably higher than or equal to 630° C., and even 650° C. The temperature corresponding to the viscosity at which the glass is formed, or approximately 10,000 poise, a temperature denoted as “T4,” is preferably lower than or equal to 1350° C.

Another object of the invention is a continuous method for obtaining substrates according to the invention, including the steps of melting a vitrifiable mixture of suitable composition in a glass furnace and of forming a glass sheet by pouring over a pool of molten tin (float method). The melting temperature is advantageously lower than 1700° C., even 1650° C.

A further object of the invention is a flat screen, especially of the LCD type (“liquid crystal display”) or OLED type (“organic light-emitting diodes),comprising a glass substrate according to the invention.

### EXAMPLES

Some of the advantages of the invention are illustrated hereinafter by means of non-limitative examples, presented in Tables 1 to 9.

Tables 1 to 9 indicate, in addition to the chemical composition expressed in percentages by weight, the following physical properties:

the “strain point”, expressed in ° C., corresponding approximately to the temperature at which the viscosity is 10^{14.5} poise (10^{13.5} Pa.s), measured according French Standard NF B30-105,

the temperature at which the viscosity is 10² poise (10 Pa.s), denoted by “T2”, measured according to ISO Standard 7884-2 and corresponding approximately to the viscosity at which the glass is fined,

the temperature at which the viscosity is 10⁴ poise (10³ Pa.s), denoted by “T4”, measured according to ISO Standard 7884-2 and corresponding approximately to the viscosity at which the glass is poured over the molten metal pool during the float method,

the coefficient of expansion between 25 and 300° C., measured according to French Standard B30-103, denoted by “α” and expressed in 10^{-7/}° C.,

the weight per unit volume or “density” (in g.cm⁻³), measured according to the “Archimedes” method.

TABLE 1

| | 1 | 2 | 3 | 4 | 5 | 6 | 7 | 8 |
|---|---|---|---|---|---|---|---|---|
| SiO₂ | 62.1 | 61.2 | 61.6 | 63.0 | 61.6 | 63.0 | 63.6 | 62.5 |
| Al₂O₃ | 14.6 | 17.0 | 18.0 | 18.7 | 15.7 | 17.9 | 14.3 | 16.0 |
| B₂O₃ | 13.4 | 12.4 | 10.6 | 10.7 | 11.1 | 10.3 | 15.7 | 10.0 |
| MgO | 6.5 | 1.0 | 4.7 | 4.4 | 5.9 | 2.7 | 2.4 | 6.5 |
| CaO | 3.4 | 2.8 | 2.7 | 3.2 | 2.6 | 6.1 | 3.9 | 3.0 |
| SrO | | 5.1 | 2.1 | | | | | 2.0 |
| BaO | | 0.5 | 0.3 | | 3.0 | | | |
| Strain point | 630 | 645 | 655 | 661 | 640 | 661 | 624 | 650 |
| T2 | 1587 | 1717 | 1654 | 1664 | 1603 | 1667 | 1665 | 1626 |
| T4 | 1232 | 1311 | 1282 | 1299 | 1258 | 1295 | 1284 | 1256 |
| α | 33 | 32 | 32 | 30 | 34 | 32 | 30 | 34 |
| Density | 2.40 | 2.42 | 2.43 | 2.40 | 2.44 | 2.40 | 2.34 | 2.44 |

TABLE 2

| | 9 | 10 | 11 | 12 | 13 | 14 | 15 | 16 |
|---|---|---|---|---|---|---|---|---|
| SiO₂ | 61.4 | 58.7 | 58.3 | 62.4 | 60.6 | 62.0 | 63.3 | 63.9 |
| Al₂O₃ | 14.3 | 16.3 | 20.4 | 17.3 | 15.7 | 16.0 | 15.3 | 15.5 |
| B₂O₃ | 14.0 | 15.7 | 13.2 | 10.9 | 15.4 | 11.0 | 12.1 | 11.1 |
| MgO | 7.2 | 5.6 | 1.6 | 4.0 | 2.7 | 4.0 | 4.6 | 1.2 |
| CaO | 3.1 | 3.7 | 4.6 | 2.6 | 4.4 | 4.0 | 4.8 | 6.2 |
| SrO | | | 1.8 | 0.0 | 0.2 | | | 0.7 |
| BaO | | | | 2.7 | 1.2 | 2.0 | | 1.4 |
| Strain point | 624 | 621 | 651 | 651 | 625 | 650 | 642 | 649 |
| T2 | 1563 | 1551 | 1643 | 1657 | 1619 | 1640 | 1632 | 1694 |
| T4 | 1214 | 1210 | 1278 | 1299 | 1258 | 1256 | 1263 | 1308 |
| α | 34 | 33 | 31 | 31 | 32 | 33 | 33 | 34 |
| Density | 2.40 | 2.39 | 2.40 | 2.42 | 2.38 | 2.43 | 2.40 | 2.40 |

TABLE 3

| | 17 | 18 | 19 | 20 | 21 | 22 | 23 | 24 |
|---|---|---|---|---|---|---|---|---|
| SiO₂ | 62.0 | 64.2 | 60.0 | 61.5 | 62.0 | 64.6 | 59.6 | 62.0 |
| Al₂O₃ | 16.0 | 17.5 | 18.0 | 17.0 | 16.0 | 16.8 | 20.1 | 16.0 |
| B₂O₃ | 11.0 | 11.0 | 14.0 | 11.0 | 11.0 | 10.8 | 12.4 | 11.0 |
| MgO | 6.0 | 5.2 | 4.0 | 4.0 | 5.0 | 2.6 | 2.9 | 6.0 |
| CaO | 4.0 | 2.1 | 4.0 | 4.5 | 4.0 | 2.8 | 5.0 | 4.0 |
| SrO | 1.0 | | | 2.0 | 2.0 | 0.5 | | |
| BaO | | | | | | 1.9 | | 1.0 |
| Strain point | 656 | 656 | 639 | 650 | 653 | 655 | 655 | 654 |
| T2 | 1643 | 1671 | 1607 | 1642 | 1652 | 1711 | 1627 | 1637 |
| T4 | 1243 | 1302 | 1255 | 1268 | 1259 | 1331 | 1274 | 1241 |
| α | 33 | 29 | 31 | 34 | 33 | 30 | 31 | 34 |
| Density | 2.42 | 2.39 | 2.39 | 2.43 | 2.42 | 2.39 | 2.40 | 2.42 |

TABLE 4

| | 25 | 26 | 27 | 28 | 29 | 30 | 31 | 32 |
|---|---|---|---|---|---|---|---|---|
| SiO₂ | 58.4 | 62.9 | 61.2 | 62.1 | 63.1 | 58.1 | 58.5 | 64.1 |
| Al₂O₃ | 20.7 | 15.3 | 16.3 | 16.6 | 16.3 | 20.5 | 17.2 | 15.5 |
| B₂O₃ | 10.7 | 14.6 | 11.7 | 10.8 | 10.4 | 15.1 | 15.5 | 11.2 |
| MgO | 5.5 | 1.4 | 6.7 | 8.2 | 5.0 | 2.2 | 2.9 | 2.6 |
| CaO | 3.6 | 2.0 | 4.0 | 2.3 | 2.3 | 4.1 | 2.2 | 6.7 |
| SrO | 0.2 | 3.4 | | | 0.3 | | 0.5 | |
| BaO | 0.9 | 0.4 | | | 2.7 | | 3.2 | |
| Strain point | 659 | 632 | 643 | 648 | 649 | 643 | 624 | 649 |
| T2 | 1585 | 1718 | 1578 | 1585 | 1653 | 1617 | 1609 | 1665 |
| T4 | 1250 | 1314 | 1230 | 1239 | 1293 | 1268 | 1264 | 1285 |
| α | 32 | 29 | 34 | 33 | 32 | 29 | 31 | 34 |
| Density | 2.44 | 2.37 | 2.42 | 2.43 | 2.43 | 2.37 | 2.40 | 2.39 |

TABLE 5

| | 33 | 34 | 35 | 36 | 37 | 38 | 39 | 40 |
|---|---|---|---|---|---|---|---|---|
| SiO₂ | 61.4 | 58.2 | 59.4 | 60.0 | 59.9 | 60.8 | 60.8 | 63.7 |
| Al₂O₃ | 16.8 | 20.2 | 20.3 | 18.0 | 19.1 | 14.6 | 20.0 | 16.3 |
| B₂O₃ | 10.7 | 11.4 | 13.7 | 10.6 | 11.4 | 15.1 | 10.6 | 12.0 |
| MgO | 8.4 | 2.2 | 1.7 | 6.4 | 1.5 | 5.6 | 3.3 | 3.6 |
| CaO | 2.8 | 5.5 | 4.8 | 4.2 | 8.0 | 3.9 | 5.2 | 4.4 |
| SrO | | 0.7 | | 0.5 | | | | |
| BaO | | 1.8 | | 0.2 | | | | |
| Strain point | 647 | 655 | 651 | 652 | 657 | 621 | 664 | 648 |
| T2 | 1568 | 1617 | 1643 | 1578 | 1627 | 1573 | 1641 | 1662 |
| T4 | 1227 | 1270 | 1285 | 1234 | 1267 | 1220 | 1284 | 1288 |
| α | 34 | 33 | 29 | 34 | 34 | 33 | 31 | 31 |
| Density | 2.44 | 2.43 | 2.38 | 2.44 | 2.41 | 2.39 | 2.41 | 2.38 |

TABLE 6

| | 41 | 42 | 43 | 44 | 45 | 46 | 47 | 48 |
|---|---|---|---|---|---|---|---|---|
| SiO₂ | 59.0 | 62.5 | 58.3 | 59.6 | 60.4 | 58.0 | 61.7 | 61.7 |
| Al₂O₃ | 19.6 | 16.2 | 19.2 | 18.9 | 18.0 | 21.4 | 18.8 | 16.8 |
| B₂O₃ | 12.3 | 14.0 | 11.4 | 14.2 | 13.8 | 11.2 | 12.9 | 12.7 |
| MgO | 5.0 | 2.2 | 3.7 | 3.4 | 2.2 | 3.2 | 2.3 | 4.8 |
| CaO | 3.8 | 5.0 | 4.2 | 2.5 | 5.0 | 4.7 | 3.7 | 3.9 |
| SrO | 0.2 | | 3.0 | 0.2 | 0.7 | 0.8 | 0.5 | |
| BaO | 0.1 | | 0.1 | 1.2 | 0.0 | 0.7 | | |
| Strain point | 650 | 638 | 652 | 640 | 642 | 661 | 651 | 642 |
| T2 | 1592 | 1656 | 1619 | 1627 | 1640 | 1615 | 1673 | 1619 |
| T4 | 1249 | 1282 | 1255 | 1276 | 1273 | 1269 | 1302 | 1260 |
| α | 32 | 31 | 34 | 29 | 31 | 32 | 29 | 32 |
| Density | 2.42 | 2.37 | 2.45 | 2.39 | 2.38 | 2.43 | 2.38 | 2.40 |

TABLE 7

| | 49 | 50 | 51 | 52 | 53 | 54 | 55 | 56 |
|---|---|---|---|---|---|---|---|---|
| SiO₂ | 65.8 | 58.5 | 65.8 | 64.2 | 64.8 | 60.9 | 59.6 | 62.6 |
| Al₂O₃ | 16.0 | 22.9 | 14.1 | 14.5 | 14.4 | 17.3 | 17.8 | 19.3 |
| B₂O₃ | 11.5 | 10.3 | 13.4 | 11.0 | 15.0 | 13.3 | 13.4 | 10.3 |
| MgO | 2.3 | 1.5 | 1.5 | 5.6 | 1.5 | 5.1 | 5.5 | 4.6 |
| CaO | 4.4 | 6.8 | 5.3 | 2.5 | 4.3 | 3.3 | 3.8 | 3.2 |
| SrO | | | | 1.9 | | | | |
| BaO | | | | 0.4 | | | | |
| Strain point | 653 | 674 | 638 | 643 | 631 | 640 | 639 | 664 |
| T2 | 1714 | 1639 | 1705 | 1658 | 1696 | 1606 | 1580 | 1659 |
| T4 | 1324 | 1288 | 1310 | 1276 | 1305 | 1253 | 1235 | 1297 |
| α | 30 | 31 | 31 | 33 | 30 | 31 | 32 | 30 |
| Density | 2.36 | 2.42 | 2.35 | 2.42 | 2.34 | 2.39 | 2.41 | 2.40 |

TABLE 8

| | 57 | 58 | 59 | 60 | 61 | 62 | 63 | 64 |
|---|---|---|---|---|---|---|---|---|
| SiO₂ | 59.5 | 59.6 | 61.9 | 58.2 | 60.5 | 60.1 | 61.4 | 66.6 |
| Al₂O₃ | 18.9 | 14.4 | 18.7 | 21.8 | 16.6 | 17.3 | 18.9 | 14.7 |
| B₂O₃ | 12.3 | 15.4 | 10.5 | 12.4 | 12.9 | 12.1 | 10.3 | 12.2 |
| MgO | 6.0 | 2.0 | 3.1 | 3.4 | 1.4 | 7.7 | 2.3 | 1.3 |
| CaO | 3.4 | 3.3 | 5.8 | 4.4 | 3.9 | 2.8 | 7.2 | 5.2 |
| SrO | | 4.3 | | | 0.3 | | | |
| BaO | | 1.0 | | | 4.4 | | | |
| Strain point | 648 | 618 | 661 | 659 | 636 | 642 | 662 | 647 |
| T2 | 1581 | 1647 | 1650 | 1611 | 1651 | 1558 | 1645 | 1728 |
| T4 | 1240 | 1258 | 1285 | 1268 | 1295 | 1220 | 1281 | 1329 |
| α | 32 | 34 | 32 | 30 | 33 | 33 | 34 | 31 |
| Density | 2.42 | 2.41 | 2.41 | 2.41 | 2.42 | 2.43 | 2.41 | 2.35 |

TABLE 9

| | 65 | 66 | 67 | 68 | 69 |
|---|---|---|---|---|---|
| SiO₂ | 58.5 | 58.9 | 62.8 | 61.5 | 61.5 |
| Al₂O₃ | 17.6 | 19.3 | 15.6 | 17.0 | 17.0 |
| B₂O₃ | 14.3 | 12.2 | 15.1 | 11.0 | 11.0 |
| MgO | 3.6 | 3.0 | 2.0 | 4.5 | 5.0 |
| CaO | 4.7 | 4.4 | 4.5 | 4.0 | 4.0 |
| SrO | 0.3 | 0.1 | | 2.0 | 1.5 |
| BaO | 1.0 | 2.1 | | | |
| Strain point | 633 | 649 | 631 | 656 | 656 |
| T2 | 1583 | 1615 | 1663 | 1672 | 1667 |
| T4 | 1238 | 1270 | 1286 | 1266 | 1264 |
| α | 33 | 32 | 30 | 32 | 32 |
| Density | 2.41 | 2.42 | 2.35 | 2.40 | 2.40 |

According to a preferred embodiment the invention glass substrate, method for providing a glass substrate, and composition preferably have or use a chemical composition comprising the following constituents, expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

M₂O denoting one or more alkali metal oxides, wherein at least one of the following provisos are met:
1.) BaO less than 1% and MgO greater than or equal to 2%;
2.) MgO greater than or equal to 4%;
3.) B₂O₃ greater than or equal to 12%.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included, Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A glass substrate having a chemical composition comprising the following constituents, expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

M₂O denoting one or more alkali metal oxides, wherein at least one of the following provisos are met:
1.) BaO less than 1% and MgO greater than or equal to 2%;
2.) MgO greater than or equal to 4%;
3.) B₂O₃ greater than or equal to 12%.

2. A glass substrate according to claim 1, wherein the content by weight of boron oxide (B₂O₃) is 12-14%.

3. A glass substrate according to claim 1, wherein the content by weight of alumina (Al₂O₃) is 15-18%.

4. A glass substrate according to claim 1, wherein the content by weight of lime (CaO) is 3-5%.

5. A glass substrate according to claim 1, wherein the content by weight of magnesia (MgO) is 4-7%.

6. A glass substrate according to claim 1, wherein the sum of the content by weight of CaO+MgO is greater than or equal to 8%.

7. A glass substrate according to claim 1, wherein the content of barium oxide (BaO) does not exceed 3%.

8. A glass substrate according to claim 1, wherein it does not contain barium oxide (BaO).

9. A glass substrate according to claim 1, wherein the content of strontium oxide (SrO) does not exceed 3%.

10. A glass substrate according to claim 1, having a chemical composition comprising the following constituents expressed in percentages by weight based on total weight:

| | |
|---|---|
| SiO₂ | 58 to 63 |
| B₂O₃ | 12 to 16 |
| Al₂O₃ | 14 to 25 |
| CaO | 2 to 10 |
| MgO | 1 to 10. |

11. A glass substrate according to claim 1, having a chemical composition comprising the following constituents expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 4 to 10. |

12. A glass substrate according to claim 1, having a chemical composition comprising the following constituents expressed in percentages by weight based on total weight:

| SiO₂ | 58 to 62 |
|---|---|
| B₂O₃ | 10 to 16 |
| Al₂O₃ | 14 to 25 |
| CaO | 2 to 4 |
| MgO | 4 to 10 |
| CaO + MgO | 8 to 12 |
| BaO | 0 |
| SrO | <3. |

13. A method for providing a glass substrate, comprising melting a vitrifiable mixture of a composition comprising the following constituents, expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

M₂O denoting one or more alkali metal oxides to form a melted vitrifiable mixture, and forming a glass sheet by pouring the melted vitrifiable mixture over a pool of molten tin, wherein in the composition at least one of the following provisos are met:
1.) BaO less than 1% and MgO greater than or equal to 2%;
2.) MgO greater than or equal to 4%;
3.) B₂O₃ greater than or equal to 12%.

14. A flat screen comprising a glass substrate according to claim 1.

15. A composition comprising the following constituents, expressed in percentages by weight based on total weight:

| | |
|---|---|
| SiO₂ | 58 to 70 |
| B₂O₃ | 10 to 16 |
| Al₂O₃ | 14 to 25 |
| CaO | 2 to 10 |
| MgO | 1 to 10 |
| BaO | 0 to 10 |
| SrO | 0 to 10 |
| M₂O | 0 to 1 |

M₂O denoting one or more alkali metal oxides, wherein in said composition at least one of the following provisos are met:
1.) BaO less than 1% and MgO greater than or equal to 2%;
2.) MgO greater than or equal to 4%;
3.) B₂O₃ greater than or equal to 12%.

16. A glass substrate according to claim 1, wherein the following proviso is met:
BaO less than 1% and MgO greater than or equal to 2%.

17. A glass substrate according to claim 1, wherein the following proviso is met:
MgO greater than or equal to 4%.

18. A glass substrate according to claim 1, wherein the following proviso is met:
B₂O₃ greater than or equal to 12%.

19. A glass substrate according to claim 10, wherein the following proviso is met:
BaO less than 1% and MgO greater than or equal to 2%.

20. A glass substrate according to claim 10, wherein the following proviso is met:
MgO greater than or equal to 4%.
